(19) United States
(12) Patent Application Publication
(10) Pub. No.: US 2005/0110766 A1
(43) Pub. Date: May 26, 2005

(54) Touch sensor with conductive polymer switches

(75) Inventors: Joel Christopher Kent, Fremont, CA (US); Chris McCoy, Natick, MA (US); Ryo Tamaki, Clifton Park, NY (US)

Correspondence Address: Tyco Electronics Corporation;Suite 140, 4550 New Linden Hill Road, Wilmington, DE, 19808, US

(73) Assignee: Elo TouchSystems, Inc., Fremont, CA (US)

(21) Appl. No.: 10/720,421

(22) Filed: Nov. 24, 2003

(51) Int. Cl. G09G 5/00

(52) U.S. Cl. 345/173

(57) ABSTRACT

The present invention is directed to touch sensors with arrays of thin-film conductive polymer switches (e.g., diodes or transistors) that can be used to selectively apply voltage gradients across a resistive touch region of the touch sensor substrate. Touches on the touch sensor can then be sensed by measuring the voltage at the touch location on the resistive touch region.

### FIELD OF THE INVENTION

The field of the present invention relates to touch sensor technology, and more particularly to resistive and capacitive touch sensor technology.

### BACKGROUND OF THE INVENTION

Touch sensors are transparent or opaque input devices for computers and other electronic systems. As the name suggests, touch sensors are activated by touch, either from a user's finger, a stylus or some other device. Transparent touch sensors, and specifically touchscreens, are generally placed over display devices, such as cathode ray tube (CRT) monitors and liquid crystal displays, to create touch display systems. These systems are increasingly used in commercial applications such as restaurant order entry systems, industrial process control applications, interactive museum exhibits, public information kiosks, pagers, cellular phones, personal digital assistants, and video games.

The dominant touch technologies presently in use are resistive, capacitive, infrared, and acoustic technologies. Touchscreens incorporating these technologies have delivered high standards of performance at competitive prices. All are transparent devices that respond to a touch by transmitting the touch position coordinates to a host computer. An important aspect of touchscreen performance is a close correspondence between true and measured touch positions at all locations within a touch sensitive area located on the touch sensor.

Referring to FIG. 1, many resistive touchscreens 10 share the following mechanical components: a rigid insulative substrate 12 with a resistive coating 16 applied thereto; and a flexible membrane coversheet 14 with a conductive coating 18 applied thereto, wherein the flexible membrane is laid over the rigid substrate 12 with the two coatings opposed and separated by spacers 20 to avoid electrical contact between the two coatings until the membrane 14 is touched.

Many resistive touchscreens on the market are referred to as “4-wire” touchscreens. In 4-wire touchscreens, both the cover sheet and the rigid substrate are required to have resistive coatings of uniform resistivity. A voltage gradient on one coating is used to measure x-coordinates of touches, and a gradient on the other coating is used to measure y-coordinates of touches. For example, FIG. 2 illustrates a 4-wire touchscreen 30 that comprises a rigid substrate 32 and a flexible membrane coversheet 34, which are shown separately for purposes of clarity. The touchscreen 30 further comprises a uniform resistive coating 36 that is applied to the rigid substrate 32, and a uniform conductive coating 38 that is applied to the flexible cover sheet 34. A pair of wires 40(1) and 40(2) are connected to resistive coating 38 at the left and right edges of the cover sheet 34 via respective electrodes 42(1) and 42(2), and a pair of wires 40(3) and 40(4) are connected to resistive coating 36 at the top and bottom edges of the cover rigid substrate 32 via respective electrodes 42(3) and 42(4).

The x-coordinate of a touch can be measured by grounding wire 40(1), supplying voltage to wire 40(2), and connecting wires 40(3) and 40(4) to a voltage sensing circuit (not shown) that preferably has a high input impedance relative to the resistivity of the coatings 36 and 38. In a similar manner, the y-coordinate of a touch can be measured by grounding wire 40(3), supplying voltage to wire 40(4), and connecting wires 40(1) and 40(2) to the voltage sensing circuit. Significantly, accurate measurements of the x- and y-coordinates of a touch require the resistivity of both coatings 36 and 38 to be uniform and stable over time. However, the formation of cover sheets over spherically curved resistive touchscreens and the mechanical flexing of the cover sheet for both flat and curved resistive touchscreens tend to degrade the uniform resistivity of the coating on the cover sheet. For example, small cracks may form in the resistive coating. Because styluses generally have sharper radii than that of fingers, thus hastening the degradation process, the resistive coating degradation problem is an even greater concern in stylus-input devices.

Another type of commercially available resistive touchscreen is referred to as a “5-wire” touchscreen, which does not require the resistivity of the coating on the cover sheet to be uniform, since the x- and y-coordinates of touches are determined based on voltage gradients on the resistive coating of the rigid substrate. For example, FIG. 3 illustrates a 5-wire touchscreen 50 that comprises a rigid substrate 52 and a flexible membrane coversheet 54, which are shown separately for purposes of clarity. The touchscreen 50 further comprises a uniform resistive coating 56 that is laid over the rigid substrate 52, and a uniform resistive coating 58 that is laid over the flexible cover sheet 54. Four wires 60(1)-(4) are connected to the coating 56 at the respective corners of the rigid substrate 52 via respective electrodes 62(1)-(4), and a fifth wire 60(5) is connected to the coating 58 on one edge of the cover sheet 54 via an electrode 62(5). To ensure that a uniform voltage gradient is created along the coating 56 of rigid substrate 52, the touchscreen 50 further comprises four resistive networks 64(1)-(4) that are disposed on the coating 56 along the periphery of the rigid substrate 52.

The x-coordinate of a touch can be measured by grounding wires 60(1) and 60(2), and supplying voltage to wires 60(3) and 60(4). The voltage on the wire 60(5) connected to the cover sheet 54 is sensed by a high impedance voltage sensing circuit to determine the x-coordinate of the touch. The y-coordinate of a touch can be measured by grounding wires 60(2) and 60(3), and supplying voltage to wires 60(1) and 60(4). The voltage on the wire 60(5) is sensed by the voltage sensing circuit to determine the y-coordinate of the touch. Significantly, the resistivity of the coating 58 on the cover sheet 54 need not be uniform or stable with time and usage in order to obtain accurate measurements of the x- and y-coordinates of a touch. The coating 58 need only provide electrical continuity and have a resistance that is small compared to the input impedance of the voltage sensing circuit. Thus, the performance of 5-wire resistive touchscreens is generally not adversely affected by any degradation in the coating 58 of the cover sheet 54, and is therefore more reliable than the 4-wire resistive touchscreens. This benefit, however, does not come without a price, since the resistive networks required for 5-wire designs add complexity to the resistive touchscreen design and manufacturing process.

Another type of resistive touchscreen is referred to as a “3-wire” touchscreen, wherein voltage gradients are applied to the resistive coating of the rigid substrate using a network of diodes. For example, FIG. 4 illustrates a 3-wire touchscreen 70 that comprises a rigid substrate 72 and a flexible membrane coversheet 74, which are shown separately for purposes of clarity. The touchscreen 70 further comprises a uniform resistive coating 76 that is applied to the rigid substrate 72, and a uniform conductive coating 78 that is applied to the flexible cover sheet 74. A first wire 80(1) is connected to the coating 76 at the left edge of the rigid substrate 72 via a first array of diodes 82(1) and at the top edge of the rigid substrate 72 via a third array of diodes 82(3). A second wire 80(2) is connected to the coating 76 at the right edge of the rigid substrate 72 via a second array of diodes 82(2) and at the bottom edge of the rigid substrate 72 via a fourth array of diodes 82(4). A third wire 80(3) is connected to the coating 78 of the flexible cover sheet 74 on one edge of the cover sheet 74 via an electrode 84. The diodes 82 serve as switches that allow voltage gradients to be selectively applied to the coating 76 of the rigid substrate 72 in the x- and y-directions, depending on which of the wires 80 is energized.

In particular, the x-coordinate of a touch can be measured by grounding the second wire 80(2), and supplying a voltage to the first wire 80(1) sufficient to forward bias the diodes of the diode arrays 82(1) and 82(2) and to apply the desired voltage gradient. Notably, when this occurs, both the first and second diode arrays 82(1) and 82(2) will become forward biased (closed switches), and both the third and fourth diode arrays 82(3) and 82(4) will become reverse biased (open switches). As a result, current will flow from the first wire 80(1), through the forward biased diode array 82(1), across the resistive coating 76 in the x-direction, through the forward biased diode array 82(2), and to the second wire 80(2). The reverse biased diode arrays 82(3) and 82(4) will prevent current from flowing in the y-direction, thereby resulting in a uniform voltage gradient in the x-direction. The voltage on the wire 80(3) connected to the cover sheet 74 is sensed by a high impedance voltage sensing circuit to determine the x-coordinate of the touch.

Similarly, the y-coordinate of a touch can be measured by grounding the first wire 80(1), and supplying a voltage to the second wire 80(2) sufficient to forward bias the diodes of the diode arrays 82(3) and 82(4) and to apply the desired voltage gradient. Notably, when this occurs, both the third and fourth diode arrays 82(3) and 82(4) will become forward biased (closed switches), and the first and second diode arrays 82(1) and 82(2) will become reverse biased (open switches). As a result, current will flow from the second wire 80(2), through the forward biased diode array 82(4), across the resistive coating 76 in the y-direction, through the forward biased diode array 82(3), and to the first wire 80(1). The reverse biased diode arrays 82(1) and 82(2) will prevent current from flowing in the x-direction, thereby resulting in a uniform voltage gradient in the y-direction. Again, the voltage on the wire 80(3) is sensed by the voltage sensing circuit to determine the y-coordinate of the touch.

As illustrated in FIG. 4, the touchscreen 70 may employ an additional set of four wires 86(1)-86(4) for sensing the temperature dependent voltage drops across the diodes. In particular, the wires 86(1)-86(4) are respectively connected to the diode arrays 82(1)-82(4) at the connection to the resistive coating 76 of the substrate 72. The voltage sensing circuitry is connected to these wires 86(1)-86(4) to compensate for any abnormal voltage variances in the diodes. As long as the voltage drop on the diodes in a given array is the same, the voltage sensing circuitry can correct for temperature drifts in diode voltage drip, variations in excitation voltages, and any drift in the offset or gain of the analog-digital-converter (ADC) used to convert the measured analog voltages into digital signals. Such touchscreens have been referred to as “7-wire” touchscreens in the marketplace. We, however, reserve this term for the touchscreens described below.

Still another type of resistive touchscreen is referred to as a “7-wire” touchscreen, wherein voltage gradients are applied to the resistive coating of the rigid substrate using a network of transistors. For example, FIG. 5 illustrates a 7-wire touchscreen 90 that is similar to the previously described 3-wire touchscreen 70, with the exception that the touchscreen 90 employs field-effect transistors (FETs), rather than diodes, as switches. In particular, a first wire 92(1) is connected to the coating 76 at the left edge of the rigid substrate 72 via a first array of FETs 94(1) and at the top edge of the rigid substrate 72 via a third array of FETs 94(3). A second wire 92(2) is connected to the coating 76 at the right edge of the rigid substrate 72 via a second array of FETs 94(2) and at the bottom edge of the rigid substrate 72 via a fourth array of FETs 94(4). Four control wires 96(1)-96(4) are respectively connected to the gates of the FET arrays 92(1)-92(4). The x- and y-coordinates of a touch can be measured by supplying a voltage to the first wire 92(1) to allow current to flow in the FETs when the gates are energized and grounding the second wire 92(2), while selectively energizing and grounding the wires 96(1)-96(4).

In particular, the x-coordinate of a touch can be measured by supplying a sufficient voltage to the control wires 96(1) and 96(2) to “turn on” the FETs in arrays 94(1) and 94(2), and grounding the control wires 96(3) and 96(4) to “turn off” the FETs in arrays 94(3) and 94(4). As a result, current will flow from the first wire 92(1), through the turned-on FET array 94(1), across the resistive coating 76 in the x-direction, through the turned-on FET array 94(2), and to the second wire 92(2). The turned-off FET arrays 94(3) and 94(4) will prevent current from flowing in the y-direction, thereby resulting in a uniform voltage gradient in the x-direction. The voltage on the wire 80(3) connected to the cover sheet 74 is sensed by a high impedance voltage sensing circuit to determine the x-coordinate of the touch.

Similarly, the y-coordinate of a touch can be measured by supplying a sufficient voltage to the control wires 96(3) and 96(4) to “turn on” the FETs in arrays 94(3) and 94(4), and grounding the control wires 96(1) and 96(2) to “turn off” the FETs in arrays 94(1) and 94(2). As a result, current will flow from the first wire 92(1), through the turned-on FET array 94(3), across the resistive coating 76 in the y-direction, through the turned-on FET array 94(4), and to the second wire 92(2). The turned-off FET arrays 94(1) and 94(2) will prevent current from flowing in the x-direction, thereby resulting in a uniform voltage gradient in the y-direction. The voltage on the wire 80(3) connected to the cover sheet 74 is sensed by a high impedance voltage sensing circuit to determine the y-coordinate of the touch.

Significantly, the 3-wire and 7-wire resistive touchscreen designs are simplistic and do not require the resistivity of the coating 78 to be uniform or stable over time. In addition, the 3-wire and 7-wire resistive designs avoid the complex and carefully tuned resistor networks of the 5-wire resistive touchscreens. Thus, it can be appreciated that either of the 3-wire and 7-wire resistive designs combines the advantages of both the 4-wire and 5-wire resistive designs. At present, however, 3-wire and 7-wire resistive touchscreens have not gained commercial acceptance, mainly because no one has developed a low-cost means to mount the diodes or transistors onto the rigid substrate, which otherwise would involve hours of manual soldering of many discrete components onto the substrate.

As such, there remains a need to provide an improved means for mounting arrays of solid state switches, such as diodes and transistors, onto touchscreen substrates.

### SUMMARY OF THE INVENTION

In accordance with a first aspect of the present invention, a touch sensor is provided. The touch sensor comprises a substrate having a resistive touch region with first and second oppositely disposed edges and third and fourth oppositely disposed edges. In the preferred embodiment, the substrate is rigid, although the substrate can also be flexible in some cases. The resistive touch region is preferably rectangular, although other types of geometries are contemplated by the present invention, depending upon the application of the touch sensor.

The touch sensor further comprises a plurality of thin film conductive polymer switches (e.g., diodes or transistors) that are arranged in first, second, third, and fourth switch arrays extending along the respective first, second, third, and fourth touch region edges. In one preferred embodiment, the switches have first and second terminals that are configured to allow electrical current conduction from the first terminal to the second terminal in a first state, and prevent electrical current conduction from the second terminal to the first terminal in a second state.

In one preferred embodiment, the switches have two layers of electrically conductive polymer (one a p-type and the other an n-type) to form a hetero-junction semiconductor device, e.g., a p-n diode or bipolar transistor. In this case, the p-type conductive polymer may be composed of doped polythiophene, poly (3,4-ethylenedioxythiophene)-poly(4-styrenesulfonate) and the n-type conductive polymer may be composed of doped poly(2-methoxy, 5-(2′-ethyl-hexyloxy)-1,4-phenylene vinylene). In other preferred embodiments, the switches may have a single layer of electrically conductive polymer to form a device, such as a Schottky diode or field-effect transistor (FET).

The touch sensor further comprises a first electrically conductive path coupled to the first and third switch arrays, and a second electrically conductive path coupled to the second and fourth switch arrays. The conductive paths may, e.g., comprise discrete electrically conductive leads and/or electrically conductive traces that extend along the respective edges of the resistive touch region. The switches of the first and second switch arrays close and the switches of the third and fourth switch arrays open when the first path is energized and the second path is grounded, and the switches of the first and second switch arrays open and the switches of the third and fourth switch arrays close when the first path is grounded and the second path is energized. In this manner, at least two voltage gradients can be selectively applied across the resistive touch region. In some embodiments, the touch sensor may comprise a cover sheet disposed over the resistive touch region, with the cover sheet comprising a resistive coating. In this case, the touch sensor further comprises an electrode extending along one edge of the resistive coating, and a third electrically conductive path coupled to the electrode. In this manner, the voltage gradients on the resistive touch region can be sensed when the coversheet is touched.

In the preferred embodiment, the touch sensor can be incorporated into a display device, in which case, the touch sensor may form a front surface of the display device, and the substrate will be transparent. The touch sensor can, however, be incorporated into other devices that do not display images, e.g., opaque touch pads or touch sensitive robot shells. The touch sensor can preferably be incorporated into a touch sensor system that comprises control electronics coupled to the first and second paths. In this case, the control electrodes are configured to alternately place the touch sensor in a first state by energizing the first path and grounding the second path, and in a second state by grounding the first path and energizing the second path. The control electronics are capable of receiving touch information from the touch sensor and determining the location of a touch on the touch sensor based on the touch information.

In accordance with a second aspect of the present inventions, a method of manufacturing a touch sensor is provided. The method comprises providing a substrate having a resistive touch region. The method further comprises forming a first metal layer along an edge of the touch region, forming a first electrically conductive polymer layer over the first electrically conductive metal layer, and forming a second metal layer over the first electrically conductive polymer layer, wherein one of the first and second metal layers is formed in electrical contact with the touch region. The first metal layer is preferably formed as spaced apart elements in order to provide discrete devices along the edge of the touch region. In the preferred embodiment, the method further comprises forming a second electrically conductive polymer layer between the first electrically conductive polymer layer and the second metal layer. In this case, one of the first and second electrically conductive polymer layers can be composed of an n-type semiconductor material, and the other of the first and second electrically conductive polymer layers can be composed of a p-type semiconductor material. If the second metal layer is designed to be in electrical contact with the touch region, an insulative material can optionally be formed between the first metal layer and the substrate. If the first metal layer is designed to be in electrical contact with the touch region, an intervening insulative layer may not be required. The method may optionally comprise securing an electrically conductive lead to the other of the first and second metal layers.

### BRIEF DESCRIPTION OF THE DRAWINGS

The drawings illustrate the design and utility of preferred embodiment(s) of the present invention, in which similar elements are referred to by common reference numerals. In order to better appreciate the advantages and objects of the present invention, reference should be made to the accompanying drawings that illustrate the preferred embodiment(s). The drawings depict only an embodiment(s) of the invention, and should not be taken as limiting its scope. With this caveat, the preferred embodiment(s) will be described and explained with additional specificity and detail through the use of the accompanying drawings in which:

FIG. 1 is a cross-section of a prior art touchscreen;

FIG. 2 is a plan view of a prior art “4-wire” touchscreen;

FIG. 3 is a plan view of a prior art “5-wire” touchscreen;

FIG. 4 is a plan view of a prior art “3-wire” touchscreen;

FIG. 5 is a plan view of a prior art “7-wire” touchscreen;

FIG. 6 is a block diagram of a touchscreen system constructed in accordance with one embodiment of the present invention;

FIG. 7 is a plan view of a 3-wire touchscreen used in the touchscreen system of FIG. 6;

FIG. 8 is an electrical schematic diagram representing a circuit formed by the touchscreen of FIG. 7;

FIG. 9 is a plot illustrating the I-V characteristic curve of the diodes within the circuit of FIG. 8 and the DC load line of the circuit of FIG. 8;

FIGS. 10-14 are plan views illustrating one preferred method of fabricating the touchscreen of FIG. 7, particularly showing the left upper corner of the touchscreen;

FIG. 14a is a cross-sectional view of the touchscreen illustrated in FIG. 14, taken along the line 14a-14a;

FIG. 14b is a cross-sectional view of the touchscreen illustrated in FIG. 14, taken along the line 14b-14b;

FIGS. 15-19 are plan views illustrating another preferred method of fabricating the touchscreen of FIG. 9, particularly showing the left upper corner of the touchscreen;

FIG. 19a is a cross-sectional view of the touchscreen illustrated in FIG. 19, taken along the line 19a-19a;

FIG. 19b is a cross-sectional view of the touchscreen illustrated in FIG. 19, taken along the line 19b-19b;

FIG. 20 is a plan view of a 7-wire touchscreen that can be used in the touchscreen system of FIG. 6;

FIGS. 21-24 are plan views illustrating one preferred method of fabricating the touchscreen of FIG. 20, particularly showing the left upper corner of the touchscreen; and

FIG. 24a is a cross-sectional view of the touchscreen illustrated in FIG. 24, taken along the line 24a-24a.

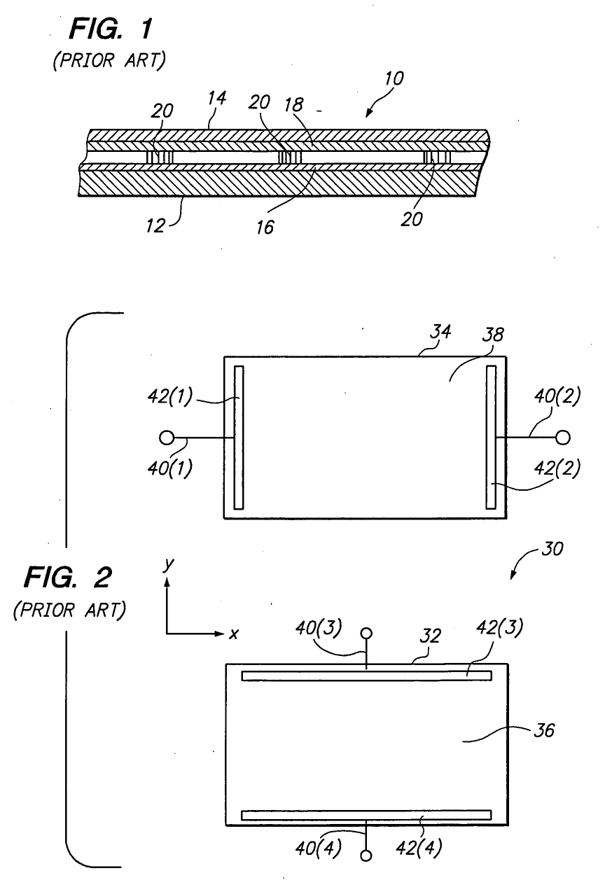

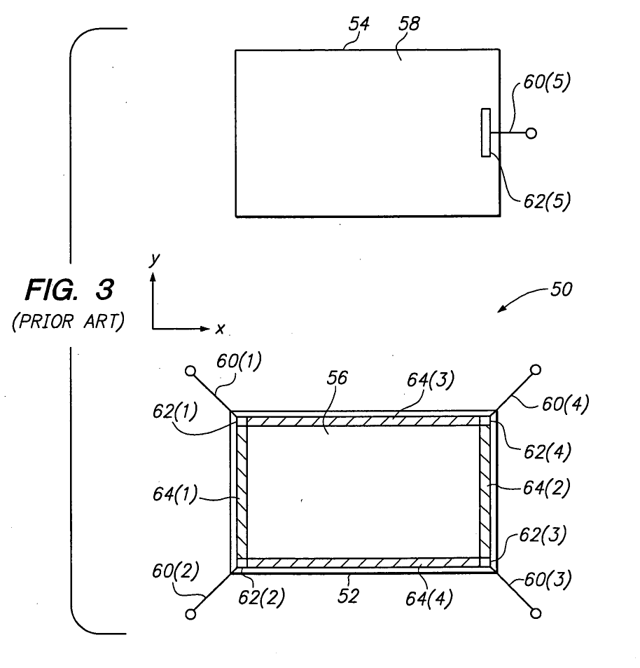

### DETAILED DESCRIPTION OF THE PREFERRED EMBODIMENTS

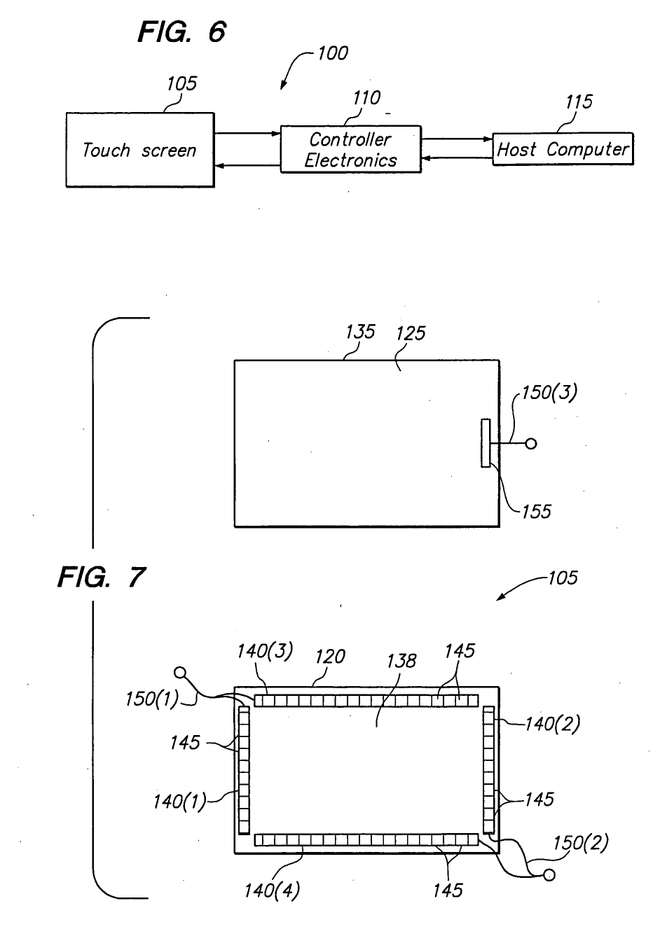

Referring to FIG. 6, a resistive touchscreen system 100 constructed in accordance with a preferred embodiment of the present invention is described. The touchscreen system 100 generally comprises a touchscreen 105 (i.e., a touch sensor having a transparent substrate), controller electronics 110, and a display (not shown). The touchscreen system 100 is typically coupled to a host computer 115. Generally, the controller electronics 110 send excitation signals to the touchscreen 105 and receive analog signals carrying touch information from the touchscreen 105. Specifically, the controller electronics 110 establish voltage gradients across the touchscreen 105. The voltages at the point of contact are representative of the position touched. The controller electronics 110 digitize these voltages and transmit these digitized signals, or touch information in digital form based on these digitized signals, to the host computer 115 for processing.

Referring now to FIG. 7, the touchscreen 105 comprises a rigid substrate 120 having a resistive touch region 130 that is formed by permanently applying a uniform resistive layer to one surface of the substrate 120. The touchscreen 105 further comprises a plastic coversheet 125 having a conductive layer 135 applied thereto. Generally, orthogonal voltage gradients will be alternately applied over the resistive touch region 130 of the touchscreen 105 via diodes 145 arranged along the respective four edges of the touchscreen 105 as four diode arrays (a left diode array 140(1), a right diode array 140(2), a top diode array 140(3), and a bottom diode 140(4)). The touchscreen system 100 employs a 3-wire architecture, and thus, a first electrically conductive lead 150(1) connects the left and top diode arrays 140(1) and 140(3) to the controller electronics 110, and a second electrically conductive lead 150(2) connects the right and bottom diode arrays 140(2) and 140(4) to the controller electronics 110. A third electrically conductive lead 150(3) connects the conductive layer 135 of the coversheet 125 to the controller electronics 110 via an electrode 155.

When the touchscreen 105 is pressed, the conductive coating 135 of the cover sheet 125 makes direct electrical contact with the resistive touch region 130 on the substrate 120. For a quasi-DC resistive touchscreen, commonly referred to as a “resistive touchscreen,” the cover sheet 125 can function as either a voltage sensing probe for sensing the voltage at the contacted area, or as a current injection source. As another option, the coversheet 125 may be replaced with a thin dielectric coating applied directly to resistive layer of the touch region 130, in which case, the controller electronics 110 may support AC operation.

The topology of the touchscreen 105 is similar to that of the touchscreen 70 previously described above. That is, the x-coordinate of a touch on the touchscreen 105 can be determined by applying a voltage to the first lead 150(1), grounding the second lead 150(2), and sensing the voltage on the third lead 150(3). Likewise, the y-coordinate of a touch on the touchscreen 105 can be determined by grounding the first lead 150(1), applying a voltage to the second lead 150(2), and sensing the voltage on the third lead 150(3). Here, the term “ground” refers to a low voltage or local ground at the touchscreen 105, which may or may not correspond to other grounds of the system.

As will be discussed in further detail below, the diode arrays 140 are applied to the touchscreen substrate 120 as thin-film conductive polymer diode arrays using a lithographic process. Before describing the composition of the diode arrays 140 and the process used for forming them on the touchscreen substrate 120, it will be useful to set forth the electrical design constraints of the diode arrays 140.

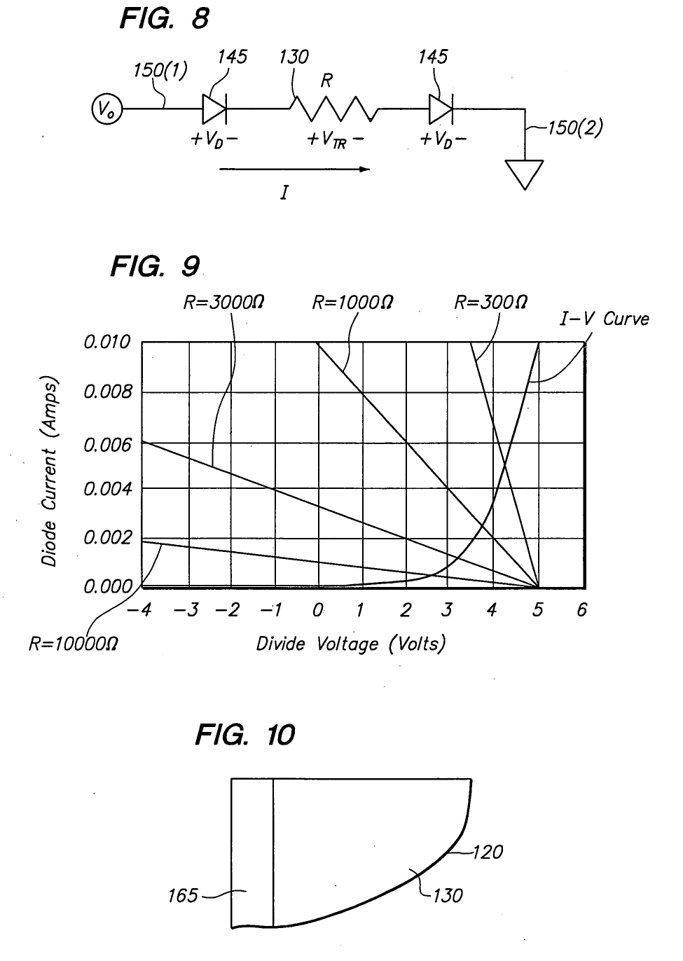

Referring specifically to FIG. 8, an electrical schematic diagram representing the circuit formed by a pair of forward biased diodes 145 and the resistive touch region 130 will be described. The forward biased diodes 145 can be one diode in the left diode array 140(1) and the corresponding opposing diode in the right diode array 140(2), while the first lead 150(1) is energized and the second lead 150(2) is grounded. The electrical circuit in FIG. 8 must satisfy the DC equation:

$$I = \frac{{V}_{O} - 2 {V}_{D}}{R} ,$$

where V_{O} is the touchscreen excitation voltage, V_{D} is the voltage drop across the forward biased diode, I is the current through the forward-biased diodes 145 and the corresponding resistive touch region, and R is the resistance of the resistive touch region area corresponding to forward-biased diodes 145. The relationship between the current and voltage of the diodes must also satisfy the I-V curve dictated by the characteristics of the diodes. The circuit current I and diode voltage V_{D} can be graphically solved by simultaneously plotting the characteristic I-V curve of the diode against the DC load line of the circuit, as illustrated in FIG. 9. Note that for I=0, the diode voltage V_{D}=V_{O}/2, and for V_{D}=0, the circuit current I=V_{O}/R. An operating voltage V_{O} of 10 volts has been selected. To illustrate the effect that the resistance value R of the resistive touch region has on the diode voltage V_{D} and the circuit current I, several DC load lines of the circuit are plotted, assuming a resistance value R of 300, 1000, 3000, and 10,000 ohms, respectively. The diode voltage V_{D} and the circuit current I can be determined from the intersection of the diode characteristic I-V curve and the DC load line of the circuit for the selected resistance value R.

In order to provide the resistive touch region with sufficient sensitivity, the ratio of the voltage drop across the resistive touch region over the operating voltage V_{TR}/V_{O} should preferably be more than 50 percent. It follows then that the diode voltage V_{D} should be as low as possible to maximize the sensitivity of the resistive touch region. As can be seen from FIG. 9, the diode voltage V_{D} can be decreased by increasing the resistance R of the resistive touch region. As a result, the voltage ratio V_{TR}/V_{O} can be advantageously increased. Notably, however, higher resistive touch regions generally increase the cost of the touchscreen and are not as readily available. The voltage ratio V_{TR}/V_{O} may theoretically be increased by increasing the operating voltage V_{O}. Because touchscreens with higher operating voltages V_{O} also increase the power requirements of the touchscreens, an operating voltage of a particular touchscreen cannot always be increased—especially when designed to be incorporated into a battery-operated device. Thus, it is often important to design or select a diode that has a low “turn-on” voltage (i.e., a diode with a steep I-V characteristic curve when forward biased). In order to minimize noise, it is also important that the diode have a low leakage current (i.e., the current flowing through the diode when reverse biased). The leakage current of a diode can be obtained by reading the current of the characteristic I-V curve on the left side of the graph in FIG. 9. Preferably, the leakage current is less than 1 percent of the forward biased current I of the diode.

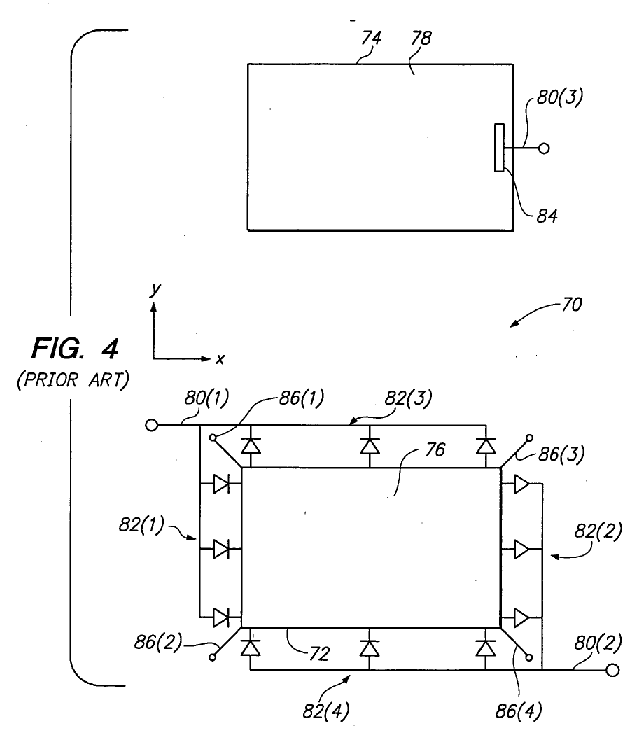

During the fabrication process, it should be appreciated that the electrical connection of the anodes and cathodes will depend on the particular location of the diode array 140 on the substrate 120. In particular, the cathodes and anodes of the left diode array 140(1) will be fabricated, such that they are in respective electrical contact with the resistive touch region 130 and first lead 150(1) (see diode array 82(1) in FIG. 4). Similarly, the cathodes and anodes of the bottom diode array 140(4) will be fabricated, such that they are in respective electrical contact with the resistive touch region 130 and second lead 150(2) (see diode array 82(4) in FIG. 4). In contrast, the anodes and cathodes of the right diode array 140(2) will be fabricated, such that they are in respective electrical contact with the resistive touch region 130 and the second lead 150(2) (see diode array 82(2) in FIG. 4). Similarly, the anodes and cathodes of the top diode array 140(3) will be fabricated, such that they are in respective electrical contact with the resistive touch region 130 and the first lead 150(1) (see diode array 72(3) in FIG. 4). As a result of these specific connections, the current will flow across the resistive touch region 130 in the desired orthogonal directions, in the same manner described in the touchscreen 70 of FIG. 4, when the leads 150(1) and 150(2) are alternately energized and grounded.

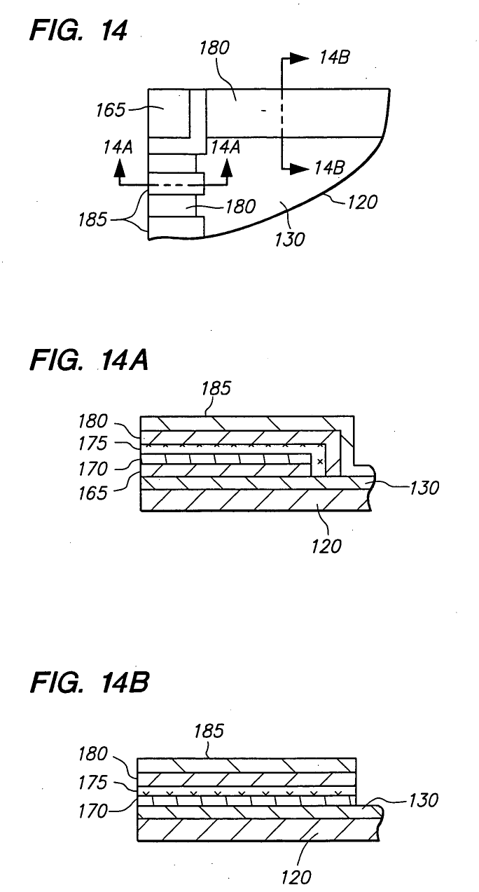

Referring now to FIGS. 10-14, one preferred method of manufacturing the diode arrays 140 onto the substrate 120 of the touchscreen 105 illustrated in FIG. 7 will now be described. First, an insulative layer 165, such as, e.g., silicone, is deposited on the periphery of the substrate 120 along the left and bottom peripheral edges (only the left peripheral edge shown) of the resistive touch region 130 though a mask (not shown) (FIGS. 10 and 14a). This insulative layer 165 serves to insulate the anodes of the left and bottom diode arrays 140(1) and 140(4) from the resistive touch region 130. Notably, the right and top peripheral edges of the resistive touch region 130 are not insulated (see top peripheral edge of FIG. 10). Alternatively, the left and bottom peripheral edges of the resistive touch region 130 can be etched away to expose the underlying insulative substrate 120, which would then serve as an insulative layer for the anodes of the left and bottom diode arrays 140(1) and 140(4).

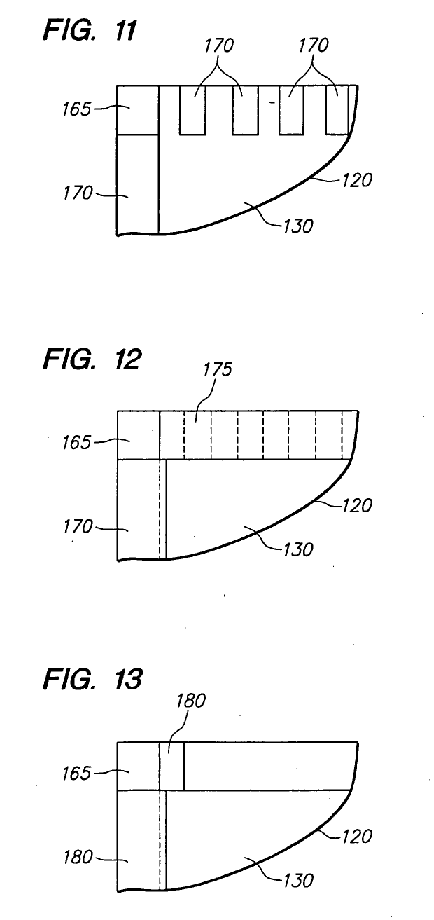

Next, a layer of anode material 170, e.g., copper, is deposited though a mask over the insulative layer 165 (FIGS. 11, 14a, and 14b). In the illustrated embodiment, the anode material is vacuum deposited through a mask as a 100-200 nm thick layer. As illustrated, the portion of the anode layer 170 disposed along the left peripheral edge (and likewise the bottom peripheral edge) of the resistive touch region 130 is formed directly on the insulative layer 165, so that it is electrically isolated from the resistive touch region 130. The portion of the anode layer 170 along the left and bottom peripheral edges of the resistive touch region 130 will, thus, serve as a connection point for the leads 150. The portion of the anode layer 170 disposed along the right and top peripheral edges (only the top peripheral edge shown) of the resistive touch region 130 is formed directly on the resistive touch region 130. This portion of the anode layer 170 is segmented into an array of anode elements, so that the respective diode arrays 140(2) and 140(3) are formed into discrete diodes 145 (shown in FIG. 7).

Next, a layer of p-type conductive polymer 175 is deposited through a mask over the anode layer 170 (FIGS. 12, 14a, and 14b) (underlying anode layer 170 shown in phantom). In the preferred embodiment, the p-type conductive polymer layer 175 is composed of polythiophene, poly (3,4-ethylenedioxythiophene)-poly(4-styrenesulfonate) (PEDOT-PSS) that is coated (e.g., spin coated) onto the anode layer 170 (diluted by 30 parts isopropanol, filtered through 0.8 μm, 3000 rpm, 40 sec) through a mask (heated at 120° C./nitrogen/3 min) to provide a 100-200 nm layer. Alternatively, other electrically conductive polymers can be used, such as acetylenes, thiophenes, phenylenes, pyrroles, or a combination thereof.

Next, a layer of n-type conductive polymer 180 is deposited though a mask over the p-type conductive polymer layer 175 (FIGS. 13, 14a, and 14b) (underlying p-type conductive polymer layer 175 shown in phantom). In the preferred embodiment, the n-type conductive polymer layer 180 is composed of poly(2-methoxy, 5-(2′-ethyl-hexyloxy)-1,4-phenylene vinylene) (MEH-PPV) that is coated (e.g., spin coated) onto the p-type conductive polymer 175 (0.5 wt % in chloroform, no filtration, 2000 rpm, 30 sec) through a silicone gel mask (heated at 80° C./nitrogen/30 sec) to provide a 100-300 nm layer.

Next, a layer of cathode material 185, e.g., aluminum, is deposited though a mask over the n-type conductive polymer 180 (FIGS. 14, 14a, and 14b). In the illustrated embodiment, the cathode material is vacuum deposited through a silicone gel mask as a 100-200 nm thick layer. As best seen in FIG. 14b, the portion of the cathode layer 185 disposed along the top peripheral edge (as well as the right peripheral edge) of the resistive touch region 130 is not in direct contact with the resistive touch region 130, and is thus, electrically isolated from the resistive touch region 130. The portion of the cathode layer 185 along the right and top peripheral edges of the resistive touch region 130 will, thus, serve as a connection point for the leads 150. As best seen in FIG. 14a, the portion of the cathode layer 185 disposed along the left peripheral edge (as well as the bottom peripheral edge) of the resistive touch region 130 is overlaid onto the resistive touch region 130 and is segmented into an array of cathode elements, so that the respective diode arrays 140(1) and 140(4) are formed into discrete diodes 145 (shown in FIG. 7).

Next, the lead 150(1) (shown in FIG. 7) is soldered to the anode layer 170 of the diode array 140(1) and the cathode layer 185 of the diode array 140(3), and the lead 150(2) (shown in FIG. 7) is soldered to the cathode layer 185 of the diode array 140(2) and the anode layer 170 of the diode array 140(4) (not shown). Alternatively, the lead 150(1) can be soldered to one of the diode arrays 140(1) and 140(3), in which case, the anode layer 170 of the diode array 140(1) can be coupled to the cathode layer 185 of the diode array 140(3), e.g., lithographically or by soldering jumper wires between the diode arrays 140(1) and 140(3). Likewise, the lead 150(2) can be soldered to one of the diode arrays 140(2) and 140(4), in which case, the cathode layer 185 of the diode array 140(2) can be coupled to the anode layer 170 of the diode array 140(4), e.g., lithographically or by soldering jumper wires between the diode arrays 140(2) and 140(4). In any event, the diode arrays 140 can optionally be encapsulated to preserve their structural integrity and to prevent electrical shorts.

It should be noted that although the previously described diode array process fabricates the anode layer 170 as the lower metal layer, and the cathode layer 185 as the upper metal layer, the roles of the upper and lower metal layers can be switched.

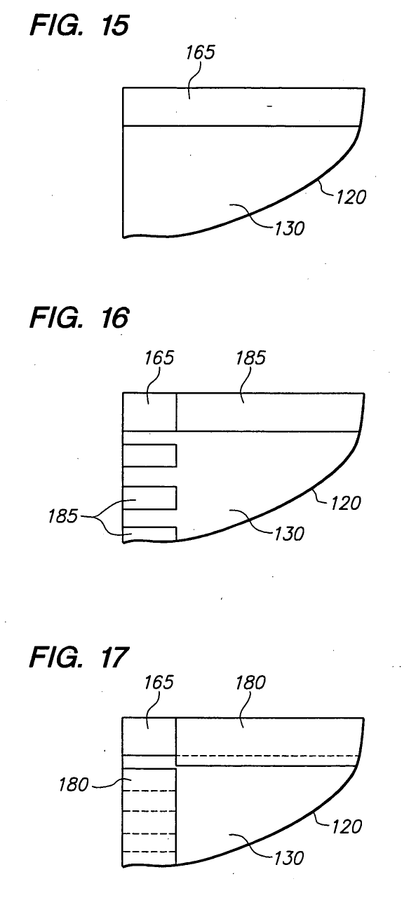

For example, FIGS. 15-19 illustrate another preferred method of manufacturing diode arrays 140 onto the substrate 120 of the touchscreen 105. First, the insulative layer 165 is deposited on the periphery of the substrate 120 along the right and top peripheral edges (only the top peripheral edge shown) of the resistive touch region 130 (FIGS. 15 and 19b). The left and bottom peripheral edges of the resistive touch region 130 are not insulated (see left edge of FIG. 15). Next, the cathode layer 185 is deposited over the insulative layer 165 (FIGS. 16, 19a, and 19b). As illustrated, the portion of the cathode layer 185 disposed along the top peripheral edge (as well as the right peripheral edge) of the resistive touch region 130 is formed directly on the insulative layer 165, so that it is electrically isolated from the resistive touch region 130. The portion of the cathode layer 185 disposed along the left peripheral edge (as well as the bottom peripheral edge) of the resistive touch region 130 is formed directly on the resistive touch region 130 and is segmented into an array of cathode elements, so that the respective left and bottom diode arrays 140(1) and 140(4) are formed into discrete diodes 140.

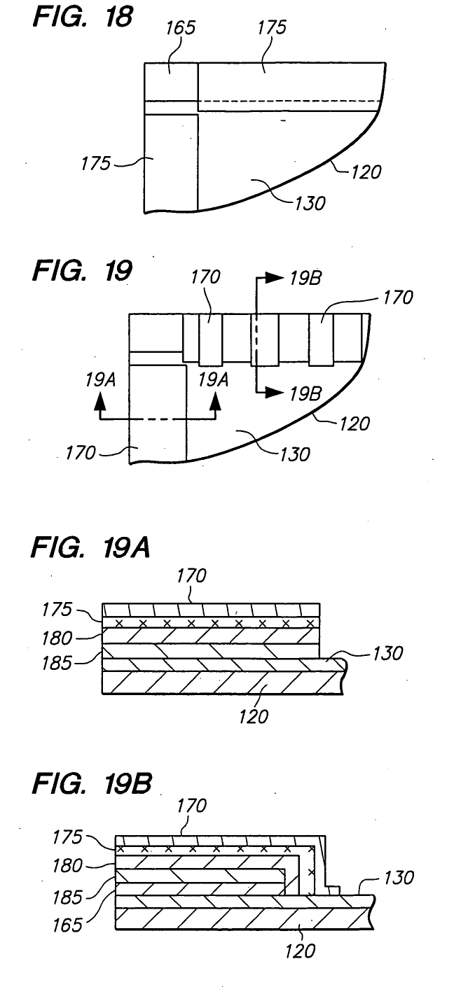

Next, the n-type conductive polymer layer 180 is deposited over the cathode layer 185 (FIGS. 17, 19a, and 19b) (underlying cathode layer 185 shown in phantom), and then the p-type conductive polymer layer 175 is deposited over the n-type conductive polymer layer 180 (FIGS. 18, 19a, and 19b) (underlying n-type conductive polymer layer 180 shown in phantom). Next, the anode layer 170 is disposed over the p-type conductive polymer layer 175 (FIGS. 19, 19a, and 19b). As best seen in FIG. 19a, the portion of the anode layer 170 disposed along the left peripheral edge (as well as the bottom peripheral edge) of the resistive touch region 130 is not in direct contact with the resistive touch region 130, and is thus, electrically isolated from the resistive touch region 130. As best seen in FIG. 19b, the portion of the anode layer 170 disposed along the top peripheral edge (as well as the right peripheral edge) of the resistive touch region 130 is overlaid onto the resistive touch region 130 and is segmented into an array of anode elements, so that the respective right and top diode arrays 140(2) and 140(3) are formed into discrete diodes 145 (shown in FIG. 7). The leads 150 may be fabricated onto the diode arrays 140 in the same manner generally described above.

Notably, even though the cathode and anode connections for each diode array may differ, the previously described fabrication process minimizes the process steps by using masks, each of which has different edge designs in order to customize the immediate layer to be applied to the different connection requirements at the peripheral edges of the touchscreen. In this manner, all four of the diode arrays 140 can be simultaneously fabricated, resulting in diode arrays with different geometries (i.e., the geometry of the left and bottom diode arrays 140(1) and 140(4) is different from that of the right and top diode arrays 140(2) and 140(3)), but identical layer deposition orders.

Alternatively, the layers within the left and bottom diode arrays 140(1) and 140(4) can be formed separately from the right and top diode arrays 140(2) and 140(3). For example, the left and bottom diode arrays 140(1) and 140(4) can be fabricated by forming the insulative layer 165, anode layer 170, p-type conductive polymer layer 175, n-type conductive polymer layer 175, and then the cathode layer 185, as illustrated in FIG. 14a. The right and top diode arrays 140(2) and 140(3) can then be fabricated by forming the insulative layer 165, cathode layer 185, n-type conductive polymer layer 175, p-type conductive polymer layer 175, and then the anode layer 170, as illustrated in FIG. 19b.

As another example, the left and bottom diode arrays 140(1) and 140(4) can be fabricated by forming the cathode layer 185, n-type conductive polymer layer 175, p-type conductive polymer layer 175, and then the anode layer 170, as illustrated in FIG. 19a. The right and top diode arrays 140(2) and 140(3) can then be fabricated by forming the anode layer 170, p-type conductive polymer layer 175, n-type conductive polymer layer 175, and then the cathode layer 185, as illustrated in FIG. 14b. Notably, no insulative layer 165 is required for this configuration.

As can be appreciated, the geometry of diode arrays 140 fabricated in accordance with FIGS. 14a and 19b are identical, with the difference being that the layer deposition order of the left and bottom diode arrays 140(1) and 140(4) is the reverse of that of the right and top diode arrays 140(2) and 140(3). Likewise, the geometry of diode arrays 140 fabricated in accordance with FIGS. 14b and 19a are identical, with the difference being that the layer deposition order of the left and bottom diode arrays 140(1) and 140(4) is the reverse of that of the right and top diode arrays 140(2) and 140(3).

Although the diode arrays 140 have been described as comprising two semiconductor materials (a p-type semiconductor material and an n-type semiconductor material), it should be noted that diode arrays can be fabricated using a single type of semiconductor material. For example, diode arrays formed from Schottky diodes, which typically utilize one layer of a semiconductor material, can be used. For example, the diode arrays 140 can alternatively use a single conductive polymer layer between anode and cathode layers. It should be noted, however, that Schottky diodes may be fabricated using more than one conductive polymer layer. For example, although it has been described here that PEDOT is a p-type polymer and MEH-PPV is an n-type polymer to form a p-n hetero-junction diode, MEH-PPV can also regarded as a p-type polymer, in which case, the PEDOT/MEH-PPV diode will act more like a Schottky diode of MEH-PPV. In this case, the PEDOT conductive polymer layer functions to increase the work function of the anode and to have better contact between the anode and the MEH-PPV. See, e.g., L. S. Roman, M. Merggren, O. Inganas, Appl. Phys. Lett. 1999, 75, 3557-3559; L. S. Roman, O. Inganas, Synth. Metals. 2002, 125, 419-422; and G. Greczynski, Th. Kugler, W. R. Salaneck, Thin Solid Films. 1999, 354, 129-135.

It can be appreciated that the previously described diodes can be characterized as switching devices that can be switched between first and second states. In particular, each diode is configured to allow electrical current conduction from a first terminal (anode) to the second terminal (cathode) when in a first state (diode is forward biased), and prevent electrical current conduction from the second terminal to the first terminal when in a second state (diode is reverse biased).

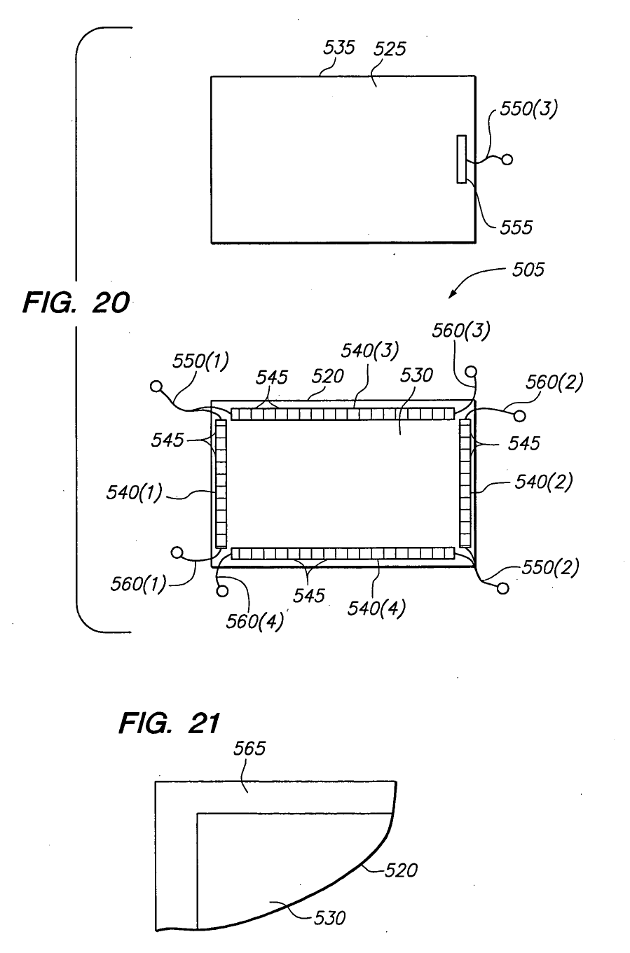

Other types of solid-state devices, such as field-effect transistors (FETs), can be used as switching devices instead. That is, each FET is configured to allow electrical current conduction from a first terminal (source) to the second terminal (drain) when in a first state (FET is on), and prevent electrical current conduction from the second terminal to the first terminal when in a second state (FET is off). For example, FIG. 20 illustrates a touchscreen 505 that uses transistors, and specifically, FETs, as switches for applying the desired voltage gradients across the touchscreen. In particular, the touchscreen 505 comprises a rigid substrate 520 having a resistive touch region 530, a coversheet 525 having a resistive layer 535, and a plurality of transistors 545 arranged along the respective four edges of the touchscreen 505 as four transistor arrays 540 (a left transistor array 540(1), a right transistor array 540(2), a top transistor array 540(3), and a bottom transistor array 540(4)).

In this case, the touchscreen system 100 employs a 7-wire architecture, and thus, a first electrically conductive lead 550(1) connects transistor arrays 540(1) and 540(3) to the controller electronics 110, and a second electrically conductive lead 550(2) connects the transistor arrays 540(2) and 540(4) to the controller electronics 110. A third electrically conductive lead 550(3) connects the resistive layer 535 of the coversheet 525 to the controller electronics 110 via an electrode 555. Four electrically conductive control leads 560(1)-560(4) are also connected between the respective transistors arrays 540(1)-540(4) and the controller electronics 110 in order to turn the respective transistors on and off.

The topology of the touchscreen 505 is similar to that of the touchscreen 90 previously described above. That is, the x-coordinate of a touch on the resistive touch region 530 can be determined by applying a voltage to the first lead 550(1), grounding the second lead 550(2), turning the left and right transistor arrays 540(1) and 540(2) on by applying a voltage to the first and second control leads 560(1) and 560(2), turning the top and bottom transistor arrays 540(3) and 540(4) off by grounding the third and fourth control leads 560(3) and 560(4), and sensing the voltage on the third lead 550(3). Likewise, the y-coordinate of a touch on the resistive touch region 530 can be determined by applying a voltage to the first lead 550(1), grounding the second lead 550(2), turning the left and right transistor arrays 540(1) and 540(2) off by grounding the first and second control leads 560(1) and 560(2), turning the top and bottom transistor arrays 540(3) and 540(4) on by applying a voltage to the third and fourth control leads 560(3) and 560(4), and sensing the voltage on the third lead 550(3).

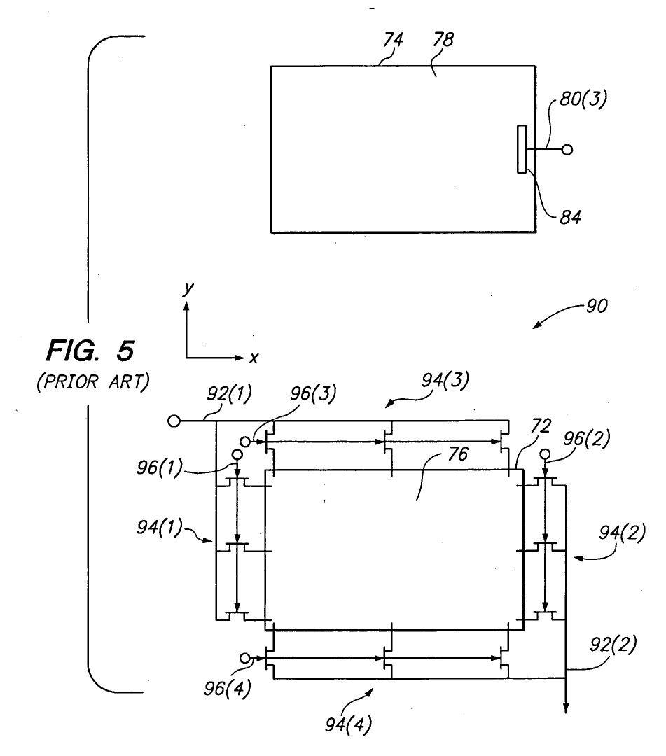

During the fabrication process, it should be appreciated that the electrical connection of the sources and drains of the transistors arrays 540 will depend on the particular transistor array 540 that is fabricated. In particular, the drains and sources of the left transistor array 540(1) will be fabricated, such that they are in respective electrical contact with the resistive touch region 530 and the first lead 550(1) (see transistor array 94(1) in FIG. 5). Similarly, the drains and sources of the top transistor array 540(3) will be fabricated, such that they are in respective electrical contact with the resistive touch region 530 and the first lead 550(1) (see transistor array 92(3) in FIG. 5). In contrast, the sources and drains of the right transistor array 540(2) will be fabricated, such that they are in respective electrical contact with the resistive touch region 530 and the second lead 550(2) (see transistor array 92(2) in FIG. 5). Similarly, the sources and drains of the bottom transistor array 540(4) will be fabricated, such that they are in respective electrical contact with the resistive touch region 530 and the second lead 550(2) (see transistor array 92(4) in FIG. 5). As a result of these specific connections, the sources of the transistor arrays 540(1) and 540(3) will remain energized, and the drains of the transistor arrays 540(2) and 540(4) will remain grounded. The current will flow across the resistive touch region 530 in the desired orthogonal directions, in the same manner described in the touchscreen 90 of FIG. 5, when the control lead pair 560(1) and 560(2) and the control lead pair 560(3) and 560(4) are alternately energized and grounded.

Like the diode arrays 140 in the touchscreen 105, the transistor arrays 540 are applied to the touchscreen substrate 520 as thin-film conductive polymer switches using a lithographic process.

Referring now to FIGS. 21-24, one preferred method of manufacturing the transistor arrays 540 onto the substrate 520 of the touchscreen 505 illustrated in FIG. 20 will now be described. First, an insulative layer 565, such as, e.g., silicone, is deposited on the periphery of the substrate 520 along the peripheral edges of the resistive touch region 530 though a mask (not shown) (FIGS. 21 and 24a). This insulative layer 565 serves to insulate the sources of the left and bottom transistor arrays 540(1) and 540(4), and the drains of the right and top transistor arrays 540(2) and 540(3) from the resistive touch region 530. Alternatively, the peripheral edges of the resistive touch region 530 can be etched away to expose the underlying insulative substrate 520, which would then serve as an insulative layer for the sources of the transistor arrays 540.

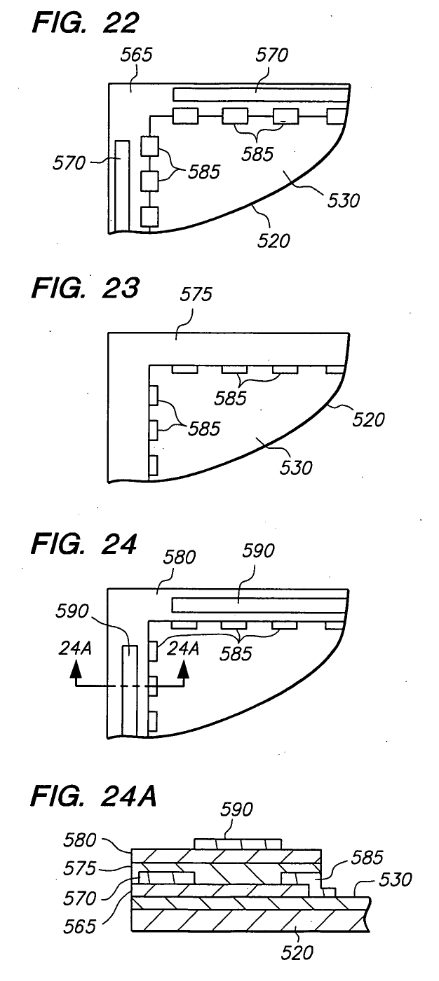

Next, a layer of metal, e.g., gold, is deposited though a mask around the outer periphery of the insulative layer 565 to form outer electrodes 570 (source electrodes for the left and top transistor arrays 540(1) and 540(3) and drain electrodes for the right and bottom transistor arrays 540(2) and 540(4)), and around the inner periphery of the insulative layer 565 in contact with the resistive touch region 530 to form inner electrodes 585 (source electrodes for the right and bottom transistor arrays 540(2) and 540(4) and drain electrodes for the left and top transistor arrays 540(1) and 540(3)) (FIGS. 22 and 24a). The portion of the metal layer 570 in contact with the resistive touch region 530 is segmented into an array of elements, so that the respective transistor arrays 540 are formed into discrete transistors 545 (shown in FIG. 20).

Next, a layer of conductive polymer 575 is deposited through a mask over the metal layer 570 (FIGS. 23 and 24a). In the preferred embodiment, the conductive polymer layer 575 is composed of regio-regular poly(3-hexyl-thiophene). Then, another layer of insulative material 580 is deposited over the conductive polymer layer 575, and another layer of metal 590, e.g., gold, is deposited along the center of the insulative material 580 to serve as the gates of the transistor arrays 540 (FIGS. 24 and 24a).

Next, the lead 550(1) (shown in FIG. 20) is soldered to the outer electrodes 570 along the left and top transistor arrays 540(1) and 540(3), and the lead 550(2) is soldered to the outer electrodes 570 along the right and bottom transistor arrays 540(2) and 540(4). Alternatively, the lead 550(1) can be soldered to the outer electrode 570 of one of the transistor arrays 540(1) and 540(3), in which case, the outer electrodes 570 of the left and top transistor arrays 540(1) and 540(3) can be electrically coupled together, e.g., lithographically or by soldering jumper wires between the transistor arrays 540(1) and 540(3). Likewise, the lead 550(2) can be soldered to the outer electrode 570 of one of the transistor arrays 540(2) and 540(4), in which case, the outer electrodes 570 of the right and bottom transistor array 540(1) and 540(2) can be coupled together, e.g., lithographically or by soldering jumper wires between the transistor arrays 540(2) and 540(4). The control leads 555(1)-555(4) are then soldered to the respective metal gate layers 585 along the four edges of the resistive touch region 530. Optionally, the transistor arrays 540 can optionally be encapsulated to preserve their structure integrity and to prevent electrical shorts.

Further details regarding the fabrication of conductive polymer transistors are described in U.S. Pat. Nos. 5,892,244 and 6,204,515, the disclosures of which are expressly incorporated herein by reference.

Although the transistor arrays 540 have been described as comprising a single semiconductor material, it should be noted that transistor arrays can be fabricated using two types of semiconductor material (a p-type semiconductor material and an n-type semiconductor material.) For example, transistors arrays formed from bipolar transistors, which utilize two types of semiconductor material, can be used. For example, the previously described transistor arrays 540 can use two conductive polymer layers between collector and emitter terminals.

Thus, it can be appreciated that the thin-film diode and transistor fabrication processes just described avoid the need to solder individual diodes or transistors onto the substrate of the touchscreen. In addition, the conductive polymer used for the semiconductor layers cures at relatively low temperatures, thereby further simplifying the fabrication process. Although the general use of conductive polymer switches is not new, conductive polymer switch technology has had limited commercial success in other technical fields due to the high switching frequency requirements of the devices to which the technology has been applied. Because touch sensors have relatively low switching frequency requirements, however, the use of conductive polymer switch technology can significantly improve the fabrication process of touch sensors without suffering from the drawbacks typically associated with high-frequency switching applications.

Although the diode arrays 140 and transistor arrays 540 have been described as being fabricated using lithography, other types of standard processes can alternatively be used to fabricate the diode arrays 140 and transistor arrays 540, including screen-printing, inkjet, roll-to-roll printing (micro contact printing technologies). Also, the diode arrays 140 and transistor arrays 540 can be fabricated as tape or sheets, which can then be cut into diode or transistor array strips and suitably adhered to the resistive touch region of the substrate to form the touch sensor. Further details regarding the use of diode and transistor tape strips for constructing touch sensors are disclosed in U.S. patent application Ser. No. 10/xxx,xxx (Attorney Docket No. ELG057 US1), which is expressly incorporated herein by reference.

Although particular embodiments of the present invention have been shown and described, it should be understood that the above discussion is not intended to limit the present invention to these embodiments. Those of ordinary skill in the art will appreciate that various changes and modifications may be made without departing from the spirit and scope of the present invention. Thus, the present invention is intended to cover alternatives, modifications, and equivalents that may fall within the spirit and scope of the present invention as defined by the claims.

1. A touch sensor, comprising:
a substrate having a resistive touch region with first and second oppositely disposed edges and third and fourth oppositely disposed edges;
a plurality of conductive polymer switches arranged in first, second, third, and fourth switch arrays extending along the respective first, second, third, and fourth touch region edges;
a first electrically conductive path coupled to the first and third switch arrays; and
a second electrically conductive path coupled to the second and fourth switch arrays;
wherein the first and second switch arrays close and the third and fourth switch arrays open when the first path is energized and the second path is grounded, and the first and second switch arrays open and the third and fourth switch arrays close when the first path is grounded and the second path is energized.

2. The touch sensor of claim 1, wherein each of the switches has two layers of electrically conductive polymer.

3. The touch sensor of claim 2, wherein one of the electrically conductive polymer layers is a p-type semiconductor layer and the other of the electrically conductive polymer layers is an n-type semiconductor polymer layer.

4. The touch sensor of claim 3, wherein the p-type conductive polymer layer is composed of doped polythiophene, poly(3,4-ethylenedioxythiophene)-poly(4-styrenesulfonate).

5. The touch sensor of claim 4, wherein the n-type semiconductor layer is composed of doped poly(2-methoxy, 5-(2′-ethyl-hexyloxy)-1,4-phenylene vinylene).

6. The touch sensor of claim 1, wherein at least portions of the first and second paths comprise electrically conductive traces that extend along the respective edges of the resistive touch region.

7. The touch sensor of claim 1, wherein the resistive touch region comprises a resistive layer, the touch sensor further comprising a coversheet disposed over the resistive touch region.

8. The touch sensor of claim 1, wherein the resistive touch region comprises a resistive layer and a dielectric layer disposed over the resistive layer.

9. A touch display, comprising:
a display device; and
the touch sensor of claim 1, wherein the touch sensor forms a front surface of the display device, and wherein the substrate is transparent.

10. A touch sensor system, comprising:
the touch sensor of claim 1; and
control electronics coupled to the first and second paths alternately placing the touch sensor in a first state by energizing the first path and grounding the second path, and in a second state by grounding the first path and energizing the second path, wherein the control electronics receives touch information from the touch sensor and determines the location of a touch on the touch sensor based on the touch information.

11. A touch sensor, comprising:
a substrate having a resistive touch region;
a plurality of conductive polymer devices arranged in a linear array extending along an edge of the resistive touch region, each of the devices having first and second terminals and being configured to allow electrical current conduction from the first terminal to the second terminal when in a first state, and prevent electrical current conduction from the second terminal to the first terminal when in a second state; and
an electrically conductive path coupled to one of the first and second terminals of the device array, wherein the other of the first and second terminals of the device array are electrically coupled to the resistive touch region.

12. The touch sensor of claim 11,
comprising first and second electrically conductive paths;
wherein the resistive touch region has first and second oppositely disposed edges and third and fourth oppositely disposed edges;
wherein the plurality of devices are arranged in first, second, third, and fourth arrays extending along the respective first, second, third, and fourth touch region edges; and
wherein the first and second terminals of the first device array are respectively electrically coupled to the first path and the resistive touch region, the first and second terminals of the second device array are respectively electrically coupled to the resistive touch region and the second path, the first and second terminals of the third device array are respectively electrically coupled to the resistive touch region and the first path, and the first and second terminals of the fourth device array are respectively electrically coupled to the second path and the resistive touch region.

13. The touch sensor of claim 11, wherein each of the devices has only the first and second terminals.

14. The touch sensor of claim 11, wherein the each of the devices comprises a third terminal for alternately placing the respective device in an on and off state, the touch sensor further comprising another electrically conductive path coupled to the third terminals of the device array.

15. The touch sensor of claim 11, wherein each of the devices has two layers of electrically conductive polymer.

16. The touch sensor of claim 15, wherein one of the electrically conductive polymer layers is a p-type semiconductor layer and the other of the electrically conductive polymer layers is an n-type semiconductor polymer layer.

17. The touch sensor of claim 16, wherein the p-type conductive polymer layer is composed of doped polythiophene, poly(3,4-ethylenedioxythiophene)-poly(4-styrenesulfonate).

18. The touch sensor of claim 17, wherein the n-type semiconductor layer is composed of doped poly(2-methoxy, 5-(2′-ethyl-hexyloxy)-1,4-phenylene vinylene).

19. The touch sensor of claim 11, wherein at least a portion of the path comprises an electrically conductive trace extending along the edge of the resistive touch region.

20. The touch sensor of claim 11, wherein the resistive touch region comprises a resistive layer, the touch sensor further comprising a coversheet disposed over the resistive touch region.

21. The touch sensor of claim 11, wherein the resistive touch region comprises a resistive layer and a dielectric layer disposed over the resistive layer.

22. A touch display, comprising:
a display device; and
the touch sensor of claim 11, wherein the touch sensor forms a front surface of the display device, and wherein the substrate is transparent.

23. A touch sensor system, comprising:
the touch sensor of claim 11, and
control electronics coupled to the first and second paths alternately placing the touch sensor in a first state by energizing the first path and grounding the second path, and in a second state by grounding the first path and energizing the second path, wherein the control electronics receives touch information from the touch sensor and determines the location of a touch on the touch sensor based on the touch information.

24. A method of manufacturing a touch sensor, comprising:
providing a substrate having a resistive touch region;
forming a first metal layer along an edge of the resistive touch region;
forming a first electrically conductive polymer layer over the first electrically conductive metal;
forming a second metal layer over the first electrically conductive polymer layer, wherein one of the first and second metal layers is formed as spaced apart elements in electrical contact with the resistive touch region.

25. The method of claim 24, further comprising forming a second electrically conductive polymer layer between the first electrically conductive polymer layer and the second metal layer.

26. The method of claim 24, wherein one of the first and second electrically conductive polymer layers is composed of an n-type semiconductor material, and the other of the first and second electrically conductive polymer layers is composed of a p-type semiconductor material.

27. The method of claim 24, further comprising forming an insulative material between the first metal and the resistive touch region, wherein the second metal is an electrical contact with the resistive touch region.

28. The method of claim 24, wherein the first metal is in electrical contact with the resistive touch region.

29. The method of claim 24, further comprising securing an electrically conductive lead to the other of the first and second metal layers.

30. The method of claim 24, wherein the resistive touch region comprises a resistive layer, and the spaced apart elements are directly coupled to the resistive layer.

31. The method of claim 24, wherein the resistive touch region comprises a resistive layer and a capacitive layer, and the spaced apart elements are directly coupled to the capacitive layer.
